(19) United States
(12) Patent Application Publication
(10) Pub. No.: US 2015/0269151 A1
(43) Pub. Date: Sep. 24, 2015

(54) Context Based Photograph Sharing Platform for Property Inspections

(71) Applicant: Andrew Wallace, Davis, CA (US)

(72) Inventor: Andrew Wallace, Davis, CA (US)

(21) Appl. No.: 14/664,851

(22) Filed: Mar. 21, 2015

Related U.S. Application Data
(60) Provisional application No. 61/969,129, filed on Mar. 22, 2014.

(51) Int. Cl. G06F 17/30; H04L 29/08

(52) U.S. Cl. CPC G06F 17/30047; H04L 67/10; H04L 67/1085; G06F 17/30525; G06Q 50/163

(57) ABSTRACT

The systems and methods of the context based sharing platform integrate cloud data storage and mobile devices across multiple users. In some embodiments, the systems and methods may be used to share photographs and inspection results which are tagged with shared and user attributes. For example, photographs may be tagged with the relevant property definition attributes and a user activity attribute, and then uploaded to a cloud server. The platform facilitates content visualization into a graphical interface based on customer needs including Portfolio, Property, Activity, and Timeline views. The software enables grouping, sorting, and searching for photographs by Property Address, Activity type, or other indicated characteristics. A queue prioritization algorithm is utilized to control the flow of instructions and content upload in order to enable multiple mobile device utilization, low mobile data utilization, and cloud report generation encompassing content from one or more mobile devices.

### CROSS-REFERENCE TO RELATED APPLICATIONS

Provisional Patent Application: U.S. 61/969,129 filed Mar. 22, 2014

### BACKGROUND

A detailed collection of property photographs is essential to any successful property management business. Photographs can help facilitate greater understanding in communications between tenants, owners, and service providers. Thorough photographic documentation is especially important when dealing with security deposit disputes and other legal matters.

Property inspections, maintenance, leasing, and marketing activities all require the capture, storage, and sharing of multiple property photographs. For a company managing 300 units, a year's worth of these activities may require more than 30,000 photographs. Additionally, property managers in some states are required by law to keep all of their property records on file for a minimum of four years. This means that at any given time, a property manager of this size would need to have about 120,000 photographs stored, catalogued, and available for immediate reference.

Therefore a need exists for systems and methods that are capable of addressing the logistical challenges of sorting, managing, searching, categorizing, and sharing the photographs and the related information.

### BRIEF SUMMARY OF THE INVENTION

The systems and methods of the context based sharing platform integrate cloud data storage and mobile devices across multiple users. In some embodiments, the systems and methods may be used to share photographs of a property which can be defined either through a web browser or on a mobile device. A property may be defined with key attributes such as Areas of a property including: number of bedrooms, number of bathrooms, other rooms, parking, outside areas, etc. In addition, an Area can be labeled with a more detailed description (eg. Bedroom 1: down hallway on left hand side). Once the key attributes of a property are defined, these definitions can be shared with selected contacts in the user's contact list or with members of a defined group or groups. Or, one's account may be configured to automatically share property attributes based on defined permissions of their group members. This critical element enables multiple users to take, share, and access photograph using the same property and area definitions on multiple devices. The photographs are uploaded to the cloud and may be appropriately tagged with the relevant property definitions attributes, and activities. Tagging a photograph with attributes can occur in the cloud, on a mobile device, or both.

The platform facilitates photograph grouping into a graphical interface based on customer needs including a Portfolio view and Timeline view. The software enables grouping, sorting, and searching for photographs by Property Address, Activity type, or other indicated characteristics. The photographs and views may be accessed through the cloud through a web browser on a computer or mobile device or the content could be synchronized with a computer or mobile device for improved local performance.

Any number of mobile devices can create new properties, set property attributes, modify property attributes, and generate content. The developed invention may include two or more synchronization data processes between the server and the mobile device(s). In one embodiment, the property attributes are given a higher upload priority over generated content.

### BRIEF DESCRIPTION OF THE DRAWINGS

FIG. 1a shows an example of the cloud platform linking mobile devices, computers, and cameras according to various embodiments described herein.

FIG. 1b shows an example of a block diagram of a server which may be used in the system or standalone according to various embodiments described herein.

FIG. 1c shows an example of a block diagram of a mobile device according to various embodiments described herein,

FIG. 1d illustrates a flowchart example regarding property inspection content generated with property and use attributes by one or more mobile devices.

FIG. 2a shows an example of a note comprising of content and attributes according to various embodiments described herein.

FIG. 2b shows an example of a shared attribute comprising property attributes and other related attributes according to various embodiments described herein.

FIG. 2c shows an example of Property Attributes consisting of the Areas associated with a property (like Bedroom or Bathroom) as well as specific Details associated with each respective area (like Closet Door or Shower)

FIG. 2d shows example of Use Attributes as defined in the process of Content creation

FIG. 3 shows a portfolio view facilitating the grouping of photograph, notes, or documents by property name and/or activity type

FIG. 4 shows the concept of a property view facilitating the viewing of all photographs for a property grouped by activities

FIG. 5 shows an activity view facilitating the viewing of all photographs for an activity on a specific date

FIG. 6 shows an example timeline view facilitating the finding of content where activities are depicted over-time.

FIG. 7 shows an edit property page facilitating adding/deleting properties and/or changing property parameters

FIG. 8. graphical interface on a client device facilitating photographs to be taken while tagged with property parameters

FIG. 9 shows a graphical interface on a client device demonstrating an example process flow for selecting from available property list with defined property parameters

FIG. 10 shows a process for creating a new property with property parameters

FIG. 11 shows an example documenting property parameter sharing for selected contacts

FIG. 12 shows an example process flow when a tenant takes a photograph of required repairs and how this photograph may be shared with others.

FIG. 13 illustrates cloud sharing of user controlled note sharing based on common shared attributes

FIG. 14 illustrates a flow chart example of a process flow for verifying shared property attributes and creating new shared property attributes according to various embodiments described herein.

FIG. 15 illustrates a flow chart of an example of a process for mobile device Generating Content according to various embodiments described herein.

FIG. 16 shows an example embodiment demonstrating permissions of group members

FIG. 17 shows an example of data in Queue, which is data on a mobile device waiting to upload to a server.

FIG. 18 shows an example of data in Queue, where new instructions are loaded to the Queue ahead of other instructions and/or Content to be uploaded to the server.

FIG. 19 illustrates a flow chart of a process flow for Queue prioritization.

### DETAILED DESCRIPTION AND BEST MODE OF IMPLEMENTATION

As used herein, the term content shall generally refer to digital images, photographs, videos, text documents, and other files containing information. In many locations in this document, a content example of photographs is used to describe the invention, but the described inventions are applicable to a much wider set of content even if only photographs are used to describe the invention.

As used herein, the term note shall generally refer to a single piece of content and its attributes

As used herein, the term attribute shall generally refer to a specific identifier that can be applied to pieces of content, notes, and certain other attributes

As used herein, the term tag shall generally refer to apply an attribute to content, notes, properties, and the like.

As used herein, the term Shared Attributes shall generally refer to property name, property address, property areas, area details and other related attributes which may be shared uniquely from content with other users.

As used herein, the term Use Attributes shall generally refer to time, creator, GPS location, Activity, Action, and Comments, and the like.

The developed invention is a framework for content creation, management, and sharing.

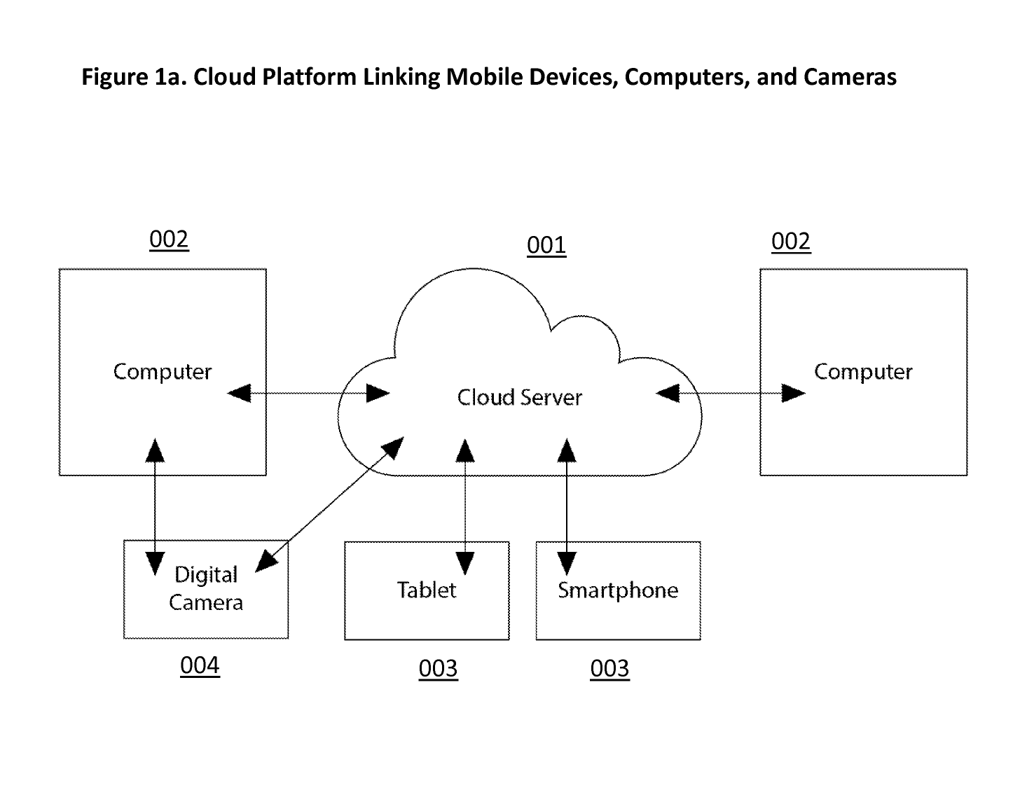

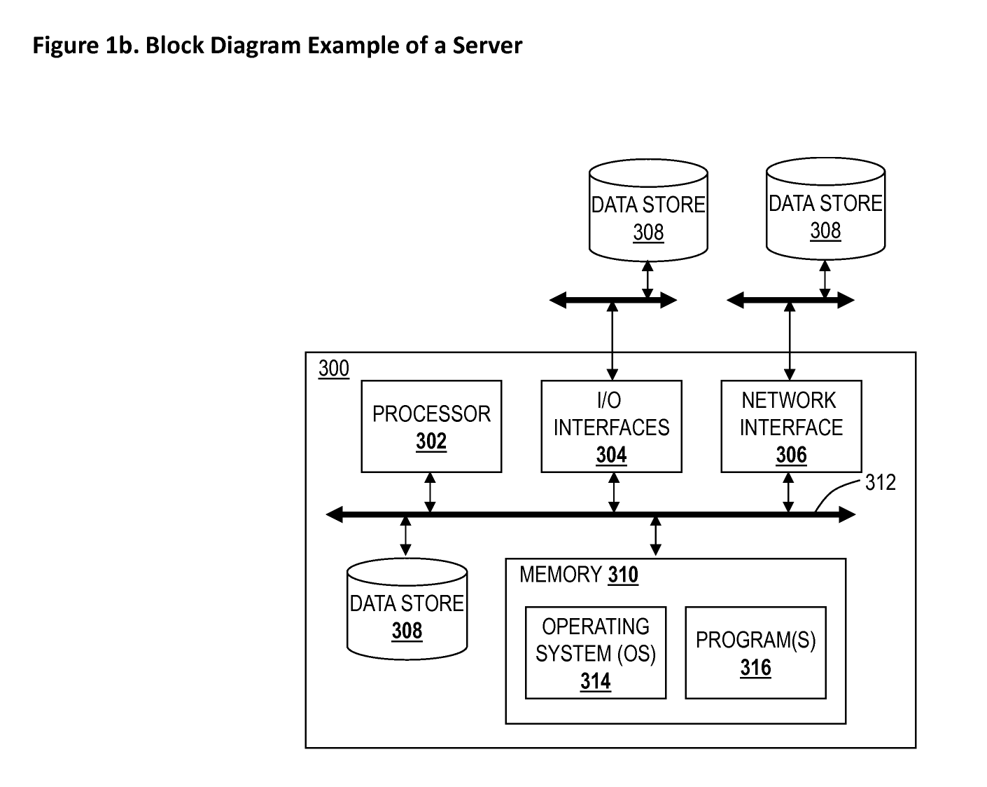

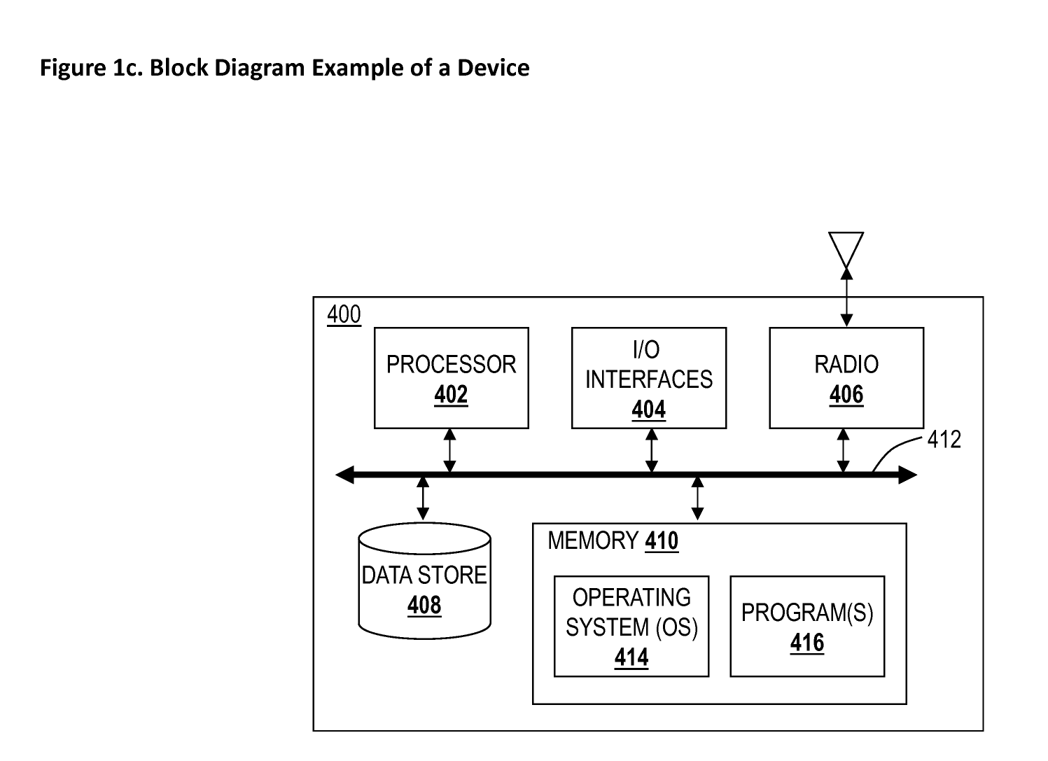

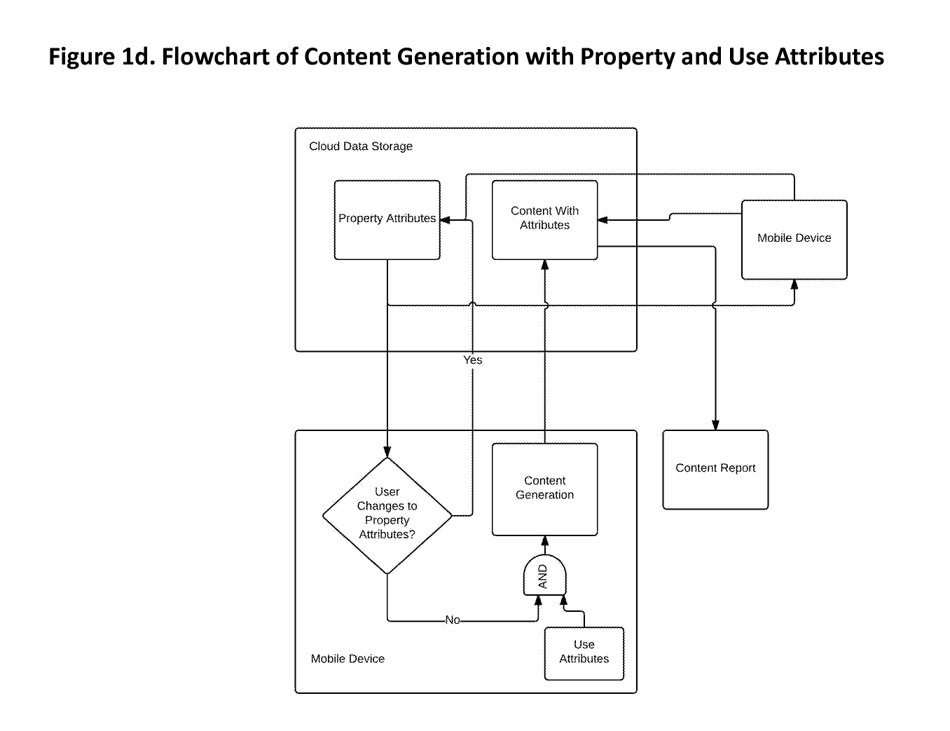

FIG. 1 shows an example of a cloud platform 001 linking mobile devices 003, computers 002, and cameras 004 according to various embodiments described herein. FIG. 1 illustrates the flow of content between computers, mobile devices, and a server. The illustration exhibits data sharing enabled by the invention. The invention enables the use of numerous mobile devices as well as standard computers and digital cameras.

FIG. 1b shows an example of a block diagram of a server which may be used in the system or standalone according to various embodiments described herein.

Referring to FIG. 1b, in an exemplary embodiment, a block diagram illustrates a server 300 which may be used in the system, in other systems, or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 1b depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, a wide area network (WAN), a local area network (LAN), and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (0/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

FIG. 1c shows an example of a block diagram of a client device according to various embodiments described herein.

Referring to FIG. 1c, in an exemplary embodiment, a block diagram illustrates a mobile device 400, which may be used in the system 100 or the like. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 1c depicts the mobile device 410 in an oversimplified manner, and a practical embodiment may include additional components and suitably configured processing logic to support known or conventional operating features that are not described in detail herein. The components (402, 404, 406, 408, and 402) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 410, a semiconductor-based microprocessor (in the form of a microchip or chip set), or generally any device for executing software instructions. When the mobile device 410 is in operation, the processor 402 is configured to execute software stored within the memory 410, to communicate data to and from the memory 410, and to generally control operations of the mobile device 410 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 410. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 1c, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with a network such as the system 100.

The context based sharing platform utilizes a server 300, data store 308, and various mobile devices 400. The developed sharing platform in the cloud 001 integrates cloud data storage 001 and mobile devices 003 across multiple users for the purpose of generating and managing property inspection data and the like. As depicted in the Flowchart in FIG. 1d, among other things, the described inventions facilitate multiple devices simultaneously generating content (such as property inspection photographs) with the ability for a single report encompassing all content to be generated from the cloud server. A property can be defined with various property attributes through a web browser, on a mobile device, and the like. The developed Property Attributes can be shared amongst users establishing a common context for content creation (such as taking photographs). The developed content is user specific with user specific generated attributes such as user activity, time-stamping, user stamp, GPS location, and the like. But the user created content can be shared with other users using the Shared Attributes as a common platform for context of the created content. One of the enabling results is a content report (such as a residential property tenant move-out inspection) which can be generated with multiple devices. For example, a tablet could be used to generate inspection notes tagged with property attributes and user activity with a mobile app, and a mobile phone could take photos tagged with property attributes and a user activity with a mobile app. The cloud server may then automatically receive this tagged content and generate a content report with content generated from two or more devices.

The cloud data storage enables unique contextual views including photograph grouping into views based on customer needs including Portfolio, Property, Activity, and Timeline views. This will further be described later. The systems and methods invented enable grouping, sorting, and searching for photographs by Property Address, Activity type, or other indicated characteristics.

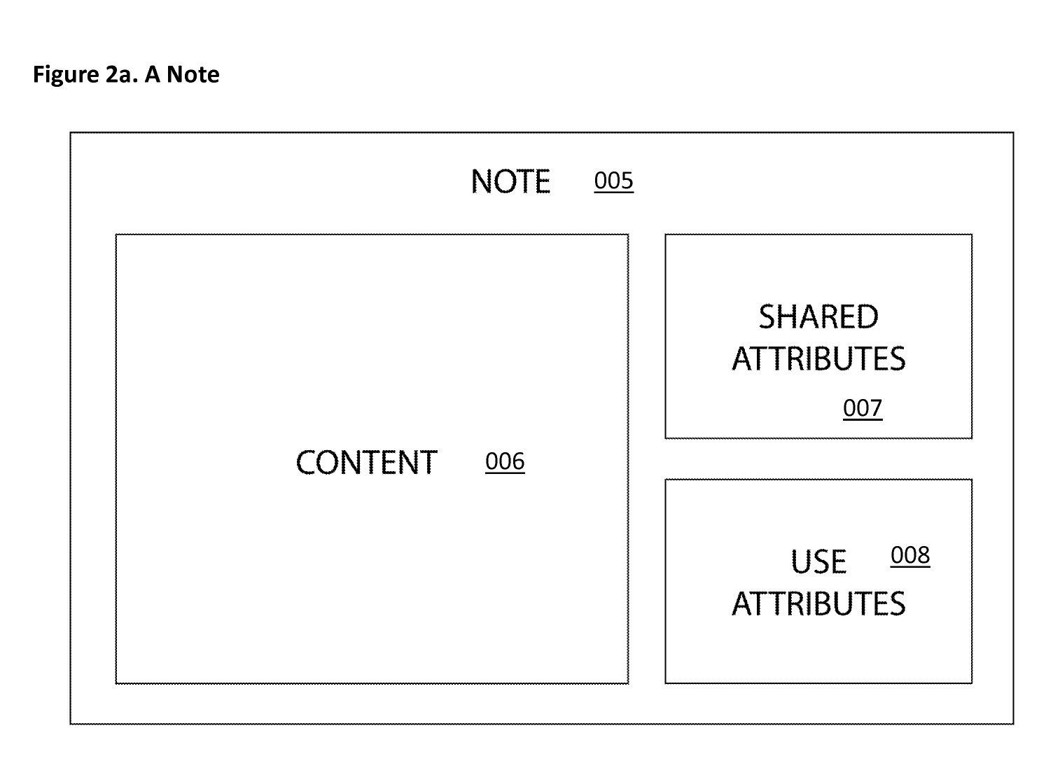

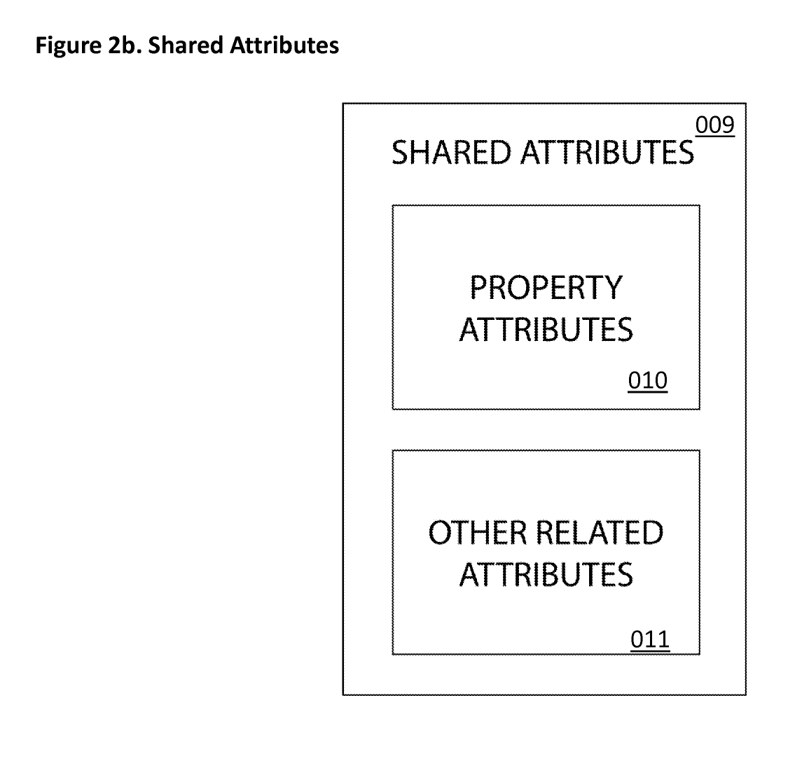

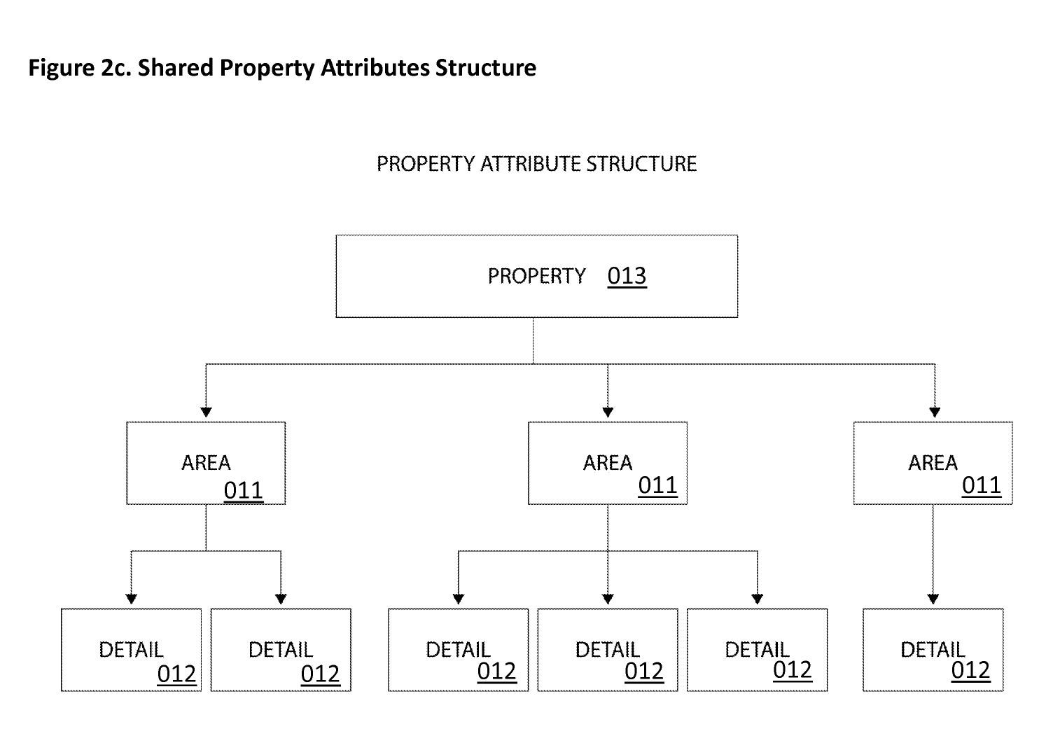

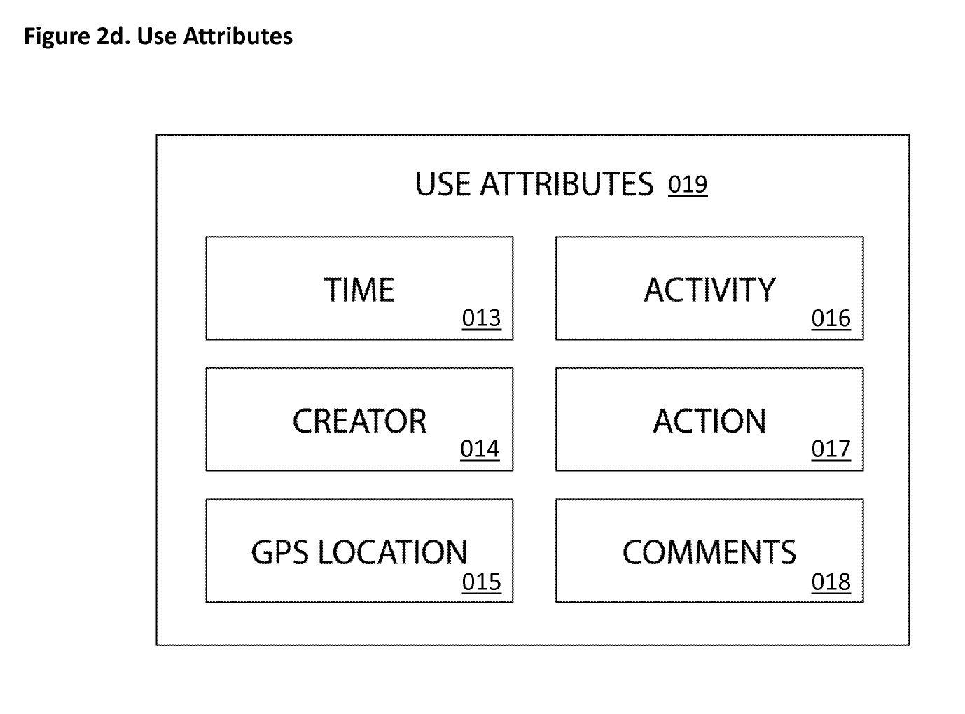

The generated content from any number of devices is more broadly defined as a note when content is tagged with attributes. FIG. 2a shows an example of a note according to various embodiments described herein. FIG. 2a illustrates an embodiment of the different parts of a Note. Each Note consists of Content 006 combined with Attributes where Attributes can be considered to be Shared 007 or Use Attributes 008.

FIG. 2b illustrates what may comprise a Shared Attribute. Shared Attributes are those that may be shared among users separately from any individual Note. Shared Attributes 009 provide Context of the generated Note. For example, Property Attributes such as the address, number of bedrooms, other areas, property amenities, etc may be shared amongst users providing a common reference point for generated Content. Even though the generated Content itself may or may not be shared. Shared Attributes may encompass Property Attributes such as number and description of bedrooms, number and description of bathrooms, or the name and description of a Property Area. A Shared Attribute may also consist of Other Related Attributes that are Shared. Other Related Attributes may include but not be limited to the following examples: applicable schools and school district of the property, preferred repair vendors, utility information, government information (such as City ordinances), community information (such as homeowner association guidelines), etc.

FIG. 2c details an example of a Shared Property Attribute and the hierarchy of such attributes. Shared Property Attributes may consist of Areas 011 which may further be tagged with Details 012. For instance, a Bedroom Area may have Details including lights, walls, closets, etc., and a Bathroom Area may have Details including: lights, walls, toilet, shower, etc. “Areas” can be used for a more broadly defined reference point including Areas like: Roof, Pool, Systems (such as security or heating and air). Shared Property Attributes may also be associated with the entire Property such as School District, GPS location, address, or other appropriate attributes.

Area examples include Back Yard/Exterior, Bathroom, Bedroom, Dining Room, Entry, Front Yard/Exterior, Garage/Parking, Hallway/Stairs, Keys/Remotes/Devices, Kitchen, Laundry Room, Loft, None, Office, Other Room, Personal Property, Roof, Pool/Spa, Roof, Safety/Security, Side Yard/Exterior, Systems, Utility Closet or other appropriate Areas.

Detail examples include Air Conditioning/Filter, Breaker Box, Building Exterior, Cabinet/Counter, Cabinet/Counter/Shelving, Cabinets/Drawers, Closet/Cabinet, Closet/Door/Track/Shelving, Counter, Dishwasher, Doorbell, Door/Knob/Lock, Driveway/Floor, Dry Rot, Eaves, Electrical/Exposed Wiring, Exhaust Fan, Faucet/Plumbing, Faucet/Valve, Fence/Gate, Fireplace/Chimney, Fireplace Equipment, Flooring/Baseboard, Furnace, Garage Door, Gutters, Keys, Landscaping, Light Fixture, Light Fixture/Fan, Mailbox/Keyed Location, None, Other, Other Door/Knob/Lock, Other Storage/Shelving, Oven/Microwave, Patio Cover, Patio/Deck/Balcony, Plumbing/Drain, Pool/Heater/Equipment, Porch/Stairs, Railing/Banister, Range/Fan/Hood/Filter, Refrigerator, Remotes/Devices, Security/Screen Door, Security System, Security Window Bars, Sewer Cleanout, Shingles/Roof Covering, Shower Door/Rail/Curtain, Sink/Disposal, Sink/Faucet, Smoke/CO Detector, Spa/Cover/Equipment, Sprinkler/Timer, Switch/Outlet, Thermostat, Toilet, Toilet Paper Holder, Towel Rack, Trash Compactor, Tub/Shower, Vent Pipes, Walk/Driveway, Walkway, Wall/Ceiling, Water Heater, Water Softener, Whole House Fan, Window Covering, Window/Lock/Screen or other appropriate Details. Available Details may be pre-selected based on selected Area.

FIG. 2d illustrates what may comprise a Use Attribute. Use Attributes 019 are those associated with a user as part of generated Content (such as taking a photograph). Use Attributes may include the Time 013 created, User/Creator 014, GPS location of user 015, Activity of Content Generation 016, Actions 017, Comments 018, and other relevant Use Attributes. An Activity Use Attribute 016 broadly groups the Activity occurring at the time of content creation into an Activity Category like: Maintenance, Repairs, Leasing, Construction, Move Out Inspection, Move In Inspection, Job Bidding, Job, or Activities as required.

Action—content may be tagged with actions. The server may use such information to later generate work orders, big requests, inspection request, or other appropriate task items. Example action categories include: Cleaning Required, Maintenance Required, Other Action Required, Repairs Required, Inspection Required, and other Action types. Action tag may also be use to tag content with Actions that have been completed.

Use attributes may include the time stamping of when content was created, the user creating the content, the GPS location during content creation as well as attributes describing the general state of the user including Activity, Action, and Comments.

Utilizing the generated content tagged with Shared and Use Attributes facilitates contextual based cloud sharing. One embodiment of the invention is a web portal software application. In one embodiment, the web portal application displays Notes in four distinct configurations based on the Attributes applied to the Notes during the upload process which are a Portfolio view, a Timeline view, a Property View, and an Activity View.

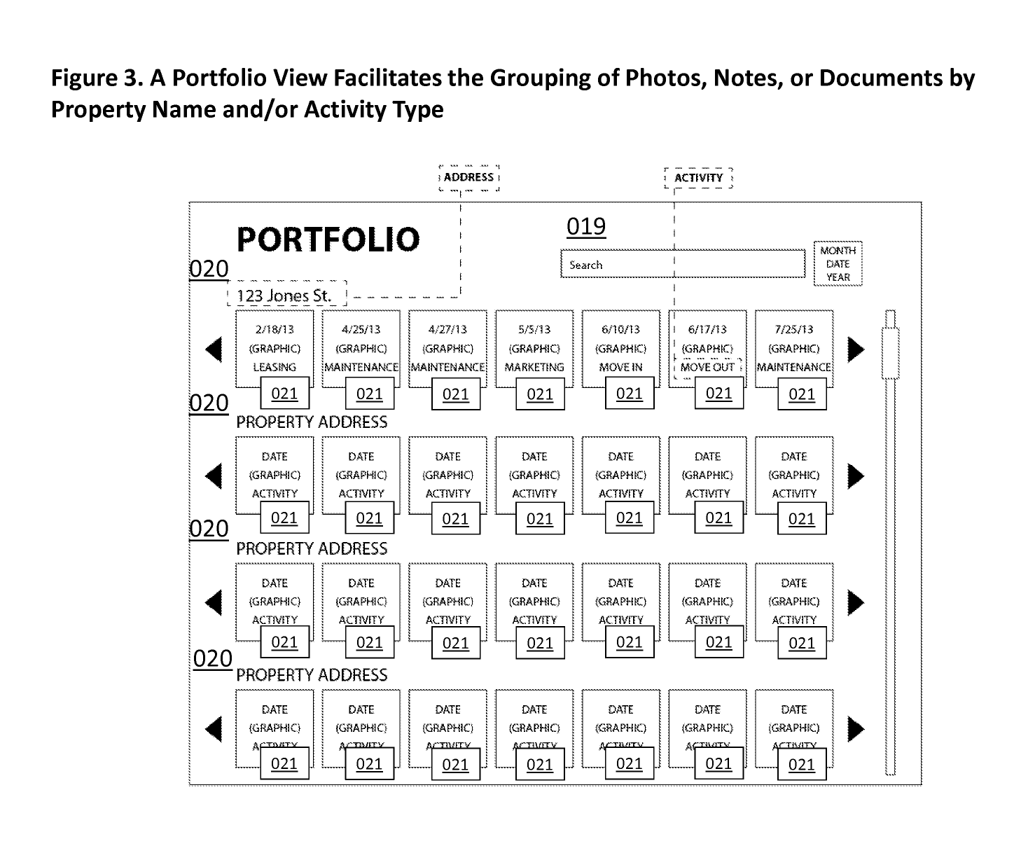

FIG. 3 is an example “Portfolio View” display option. This figure depicts how photographs (or content) may be grouped by property names 020 (or addresses) into Activities 021. The view is referred to as a carousel as it allows the user to scroll through activities to rapidly find photograph of interest like Maintenance, Move-In, Move-out, Inspection, Repairs, Leasing, Marketing, and the like.

This configuration may further filter Notes by Property Attribute and may group them based on Activity Attribute. Groups of Notes with the same Activity Attribute may be separated into discreet collections by Date and displayed chronologically in a separate carousel for each Property 020. These carousels may be displayed in alphabetical order by Property. The user can optionally filter which Property carousels are displayed by using the configuration's search bar 019. Property names that do not match the entered search criteria are hidden until the search field is cleared. The user can view the Note collections with a particular Date Attribute by clicking said date on the Portfolio View's date selector. The chronological list of Note collections will scroll left or right so that the collection(s) tagged with the selected Date may be displayed in the center of the carousel. The user can also use the arrow buttons on the left and right of the carousel to optionally scroll through the collections one by one.

Using custom icons to display activities enables the user to quickly scan and access a high number of photographs (or other content) based on the content attributes.

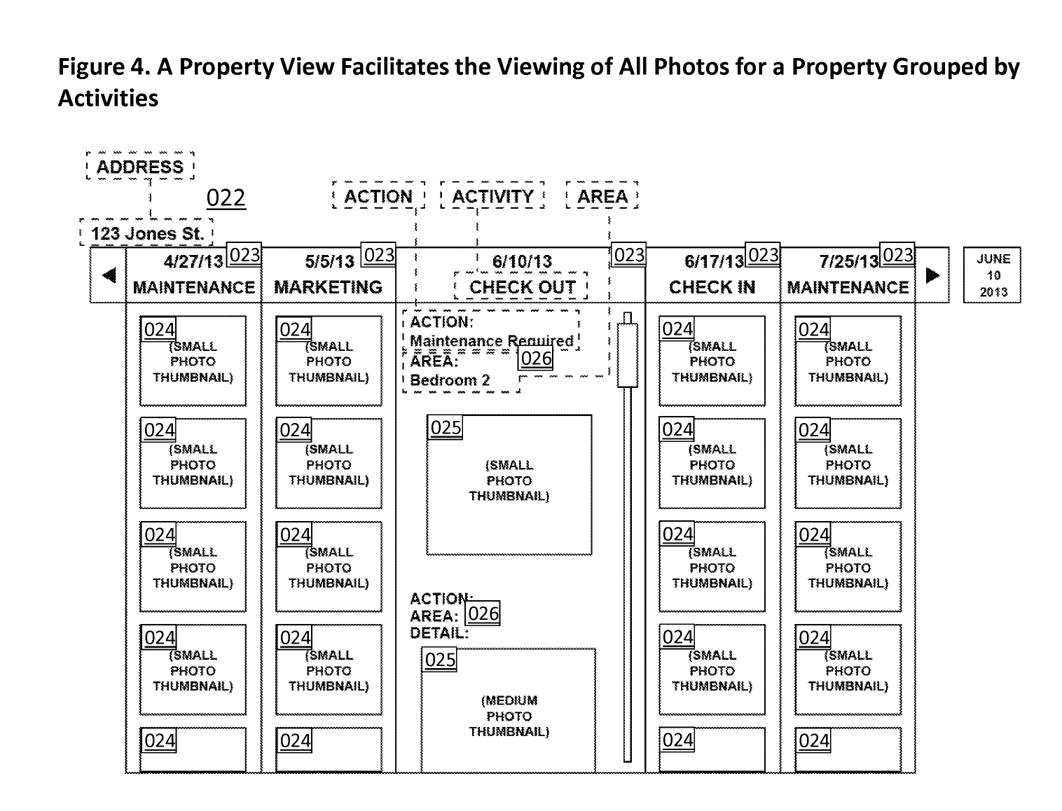

FIG. 4 is an example “Property View” display configuration. This view facilitates the viewing of a large number of photographs grouped by Activities 024 for a particular property 022. This configuration may group a specific Property's Notes that have the same Activity and Date Attributes into discreet collections 023, and may display the collections chronologically. Alternative views may filter specific activities or content with specific attributes. The collections may be displayed as a series of thumbnail previews in a dynamic carousel module. The user can view the Note collections tagged with a specific Date Attribute by clicking said date on the Property View's date selector. The chronological list of Note collections may scroll left or right so that the collection(s) tagged with the selected Date Attribute are displayed in the center of the carousel. The user can also use the arrow buttons on the left and right of the carousel to scroll through the collections one by one.

The Property View may also provides the user with a means to upload content to the web portal from a computer.

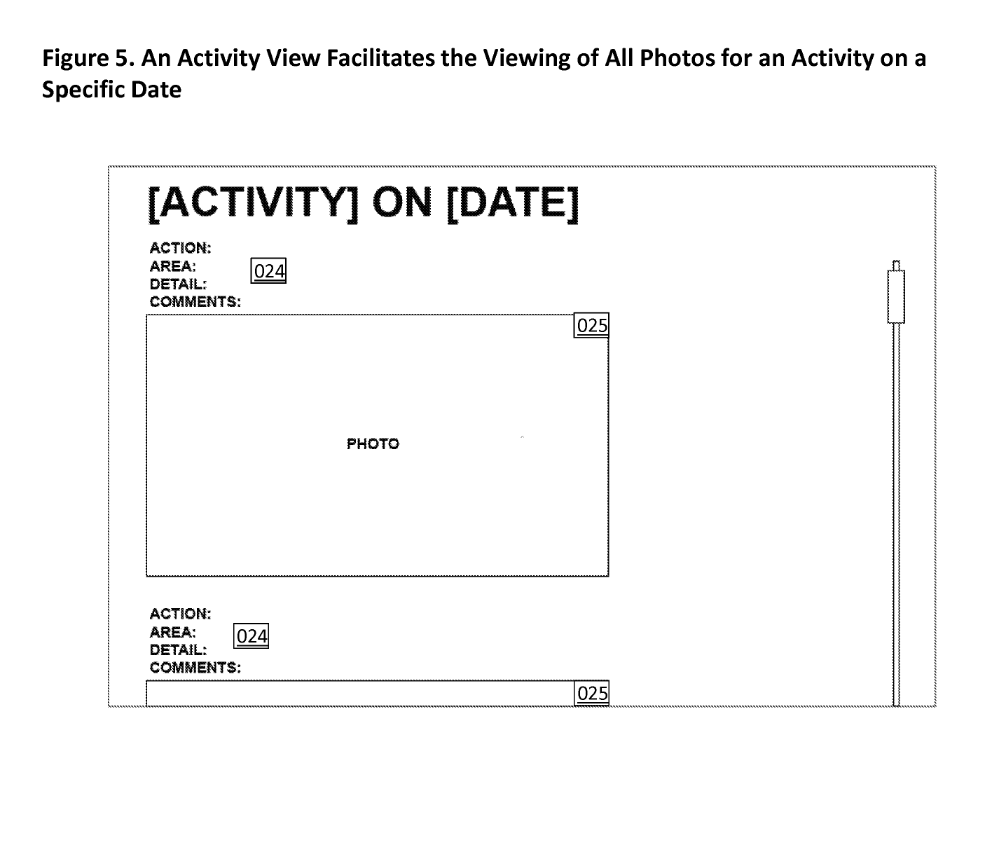

FIG. 5 is an example “Activity View” display option. This view facilitates enhanced detail of generated content for a selected Activity and/or Property. This view may also facilitate the selecting of photographs 025 for report generation. This configuration preferably displays all Notes from a specific Activity on a specific Date at a single Property. The content in each Note may be displayed in a separate row, accompanied by its Area, Detail, Action, and Comments Attributes 024. The Activity View provides the user with the options to download the content of the Note to their hard drive or other local storage, edit the Attributes of a specific Note, or to delete the Note entirely. This configuration also has the capability to generate a report that is populated by the Notes' content and certain Attributes. The user has the option to select or deselect which Notes are to be included in the report. The report can be published to the web, downloaded to a hard drive, sent as an email attachment, or exported to various cloud storage services.

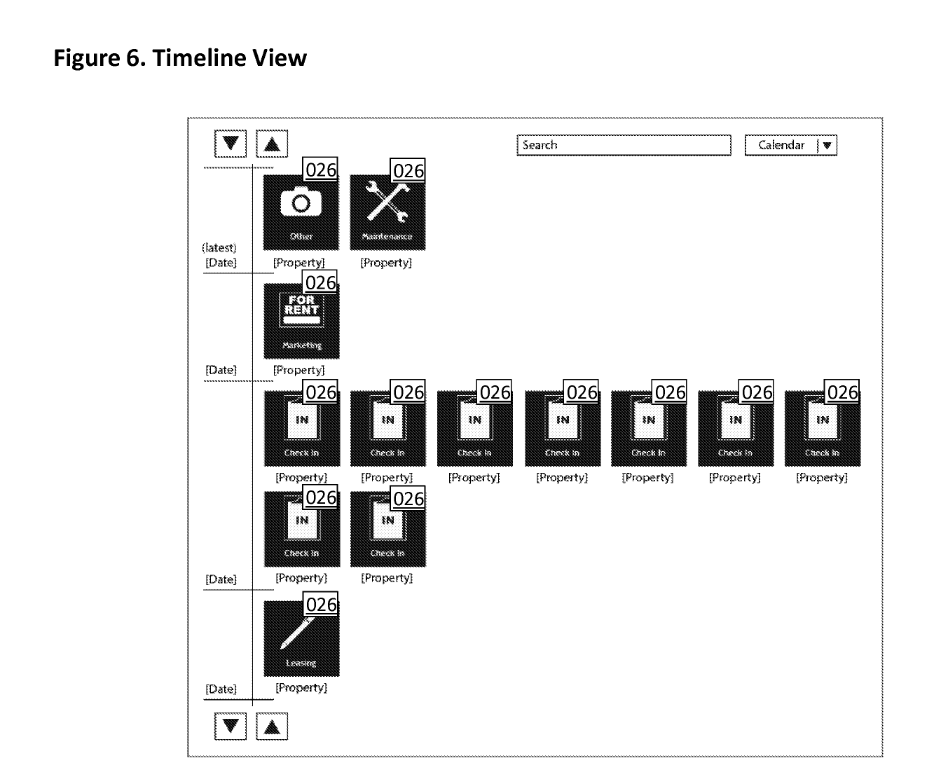

FIG. 6 is the “Timeline View” display configuration. Timeline View facilitates viewing of Activities 026 by date for someone to easily track the timeline of all generated user content across properties including their group member properties.

This configuration groups Notes with the same Property, Activity, and Date Attributes into discreet collections, and displays the collections chronologically. The user can filter which Note collections are displayed by using the configuration's search bar. Note collections that do not match the entered search criteria may be hidden until the search field is cleared. The user can view the Note collections tagged with a particular Date Attribute by clicking said date on the Timeline View's date selector. The chronological list of Note collections may scroll up or down so that the collections on the selected Date are displayed at the top of the Timeline View. The user can also use the arrow buttons at the top and bottom of the Timeline View to scroll through the Dates one by one.

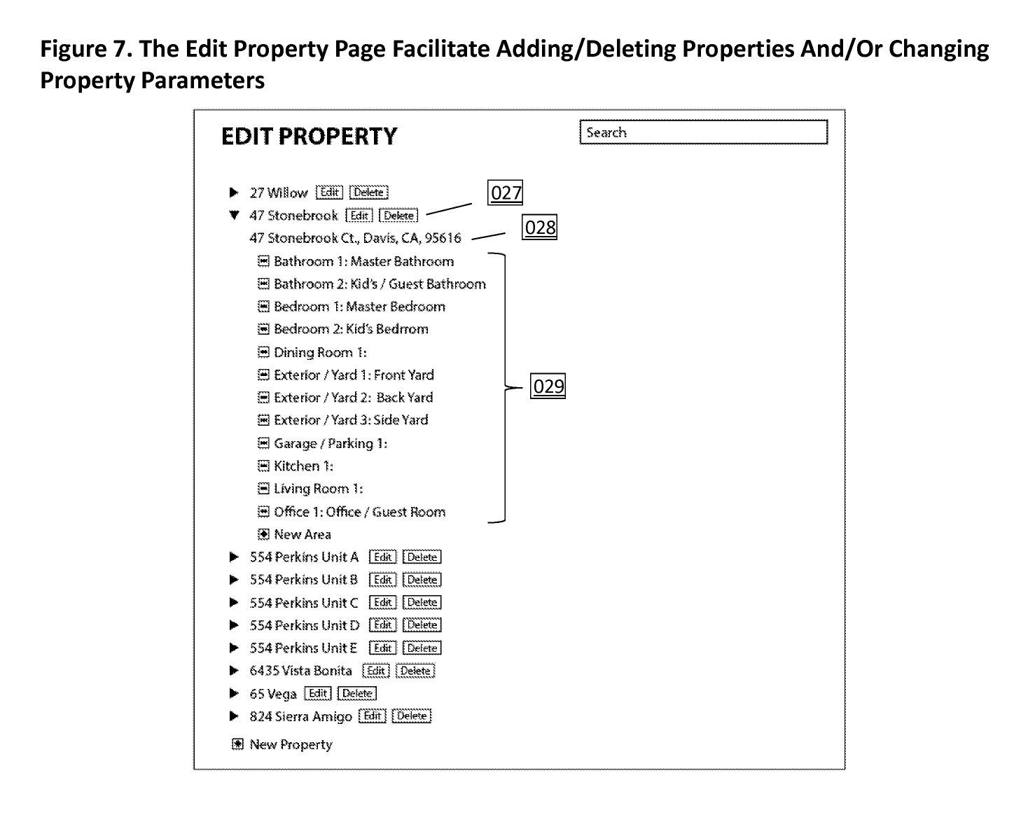

FIG. 7 an example web portal application's “Edit Property” page. The edit property page enables the editing of property characteristics such as adding or deleting Areas (like Bedrooms and Bathroom). Any modifications or additions to Property Attributes or Properties on the web server will be pushed down to mobile devices. The Edit Property page may display all Property Attributes and Parameters stored in the user's database. From this page, the user can add new Property Attributes to the database and edit existing Property Attributes. To create a new property in the databse, the user may define the “Property Name”—the word or phrase that will represent an example Shared Property Attribute. The address associated with the property may also be a Shared Property Attribute. Once a Property Attribute has been entered into the database, the user can select which Area Attributes the database may apply to the Property Attribute. To add an Area Attribute to a property, the user may select an Area Attribute from the database's list of possible Areas and assign a number to the selected Area. The user also has the option to assign a brief description to the Area Attribute before confirming its creation. The user can filter which properties are displayed by using the configuration's search bar. Properties that do not match the entered search criteria may be hidden until the search field cleared. Every property in the user's database may be automatically listed in the Portfolio View configuration and given a Property View configuration page.

Another embodiment of the invention comprises a systems and methods for use on a client device which may be a tool for content creation, but it is within the scope of the invention to fulfill similar functions to those of the web portal.

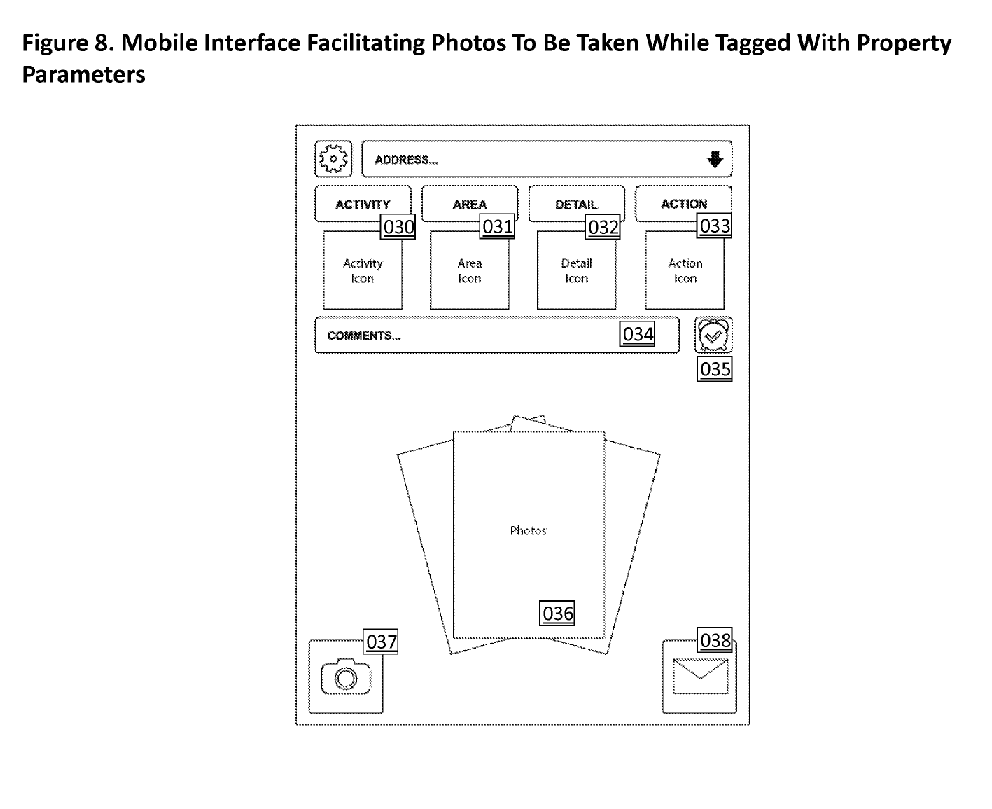

FIG. 8 is an example of a mobile device interface. This is an example layout of a photo inspection scene on a mobile application. This scene may be first used to set Content Attributes to be applied such as Property Address, Photograph Activity 030, Area 031, Detail 032, and Action 033. This view also facilitates the user adding Comments [034]. Graphics may be shown exhibiting the user selections. In the example scene, tapping on the photo button [037] opens the device camera as example way of collecting content. Upon completion of taking a photo, a note is created encompassing the photo content and the applicable Shared and User Content attributes. This note is added to the upload queue which is described later.

Other scenes could be created on the mobile app to generate or collect other types of content such as acoustic readings, audio recordings, video recordings, temperature readings, or other content which would also be tagged with the Shared and Use attributes. Examples of the different content attributes include: Activity, Action, Area, and Detail. In one embodiment, the mobile app must have at the lease the Property Address Shared Attribute and Activity Use Attribute determined prior to taking a photo.

Property lists and Shared Property Attributes such as Areas may be automatically synchronized between the webserver and mobile application's database upon completion of a successful login attempt and as a periodic recurring background process.

Certain Use Attributes may be applied to generated content. Example Attributes include: (1) the Date of content creation; (2) the Time of content creation; (3) the GPS location of where the content was created;” and (4) the “Activity,” or purpose of content creation.

In one embodiment of this invention (FIG. 08), a user selects or enters a property name or address. The user can rapidly choose to apply four example Attributes to the piece of content, which are as follows: (1) an “Area,” or particular room or section of the Property that is depicted or described by the content; (2) a “Detail,” or specific aspect of the selected Area; (3) a required or completed “Action;” and (4) any “Comments” the user wishes to attach to the content. In other embodiments, the user may apply between one or more attributes to the piece of content.

The Action attribute may include a Priority level. In one embodiment, if a Repair Required Action is specified and the Action is given a high priority, the queue upload process may prioritize this content upload over other generated content.

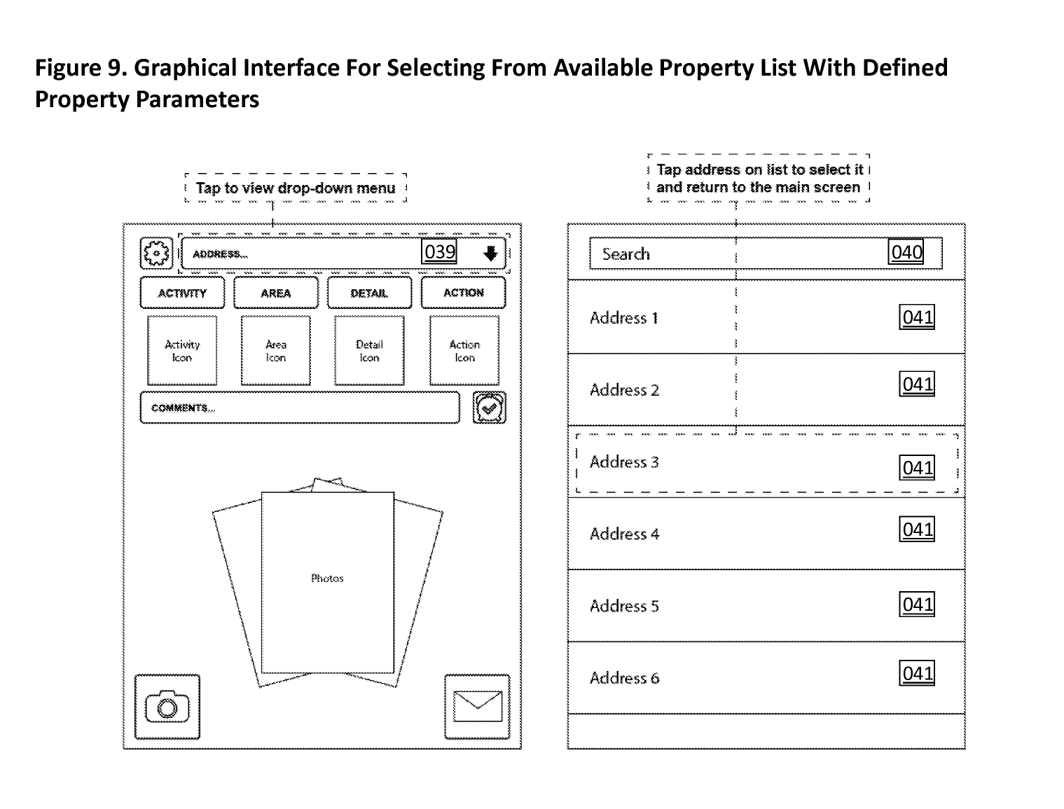

FIG. 09 illustrates a graphical interface example for selecting from available previously created properties by scrolling and selecting 041 or searching 040 from the property list.

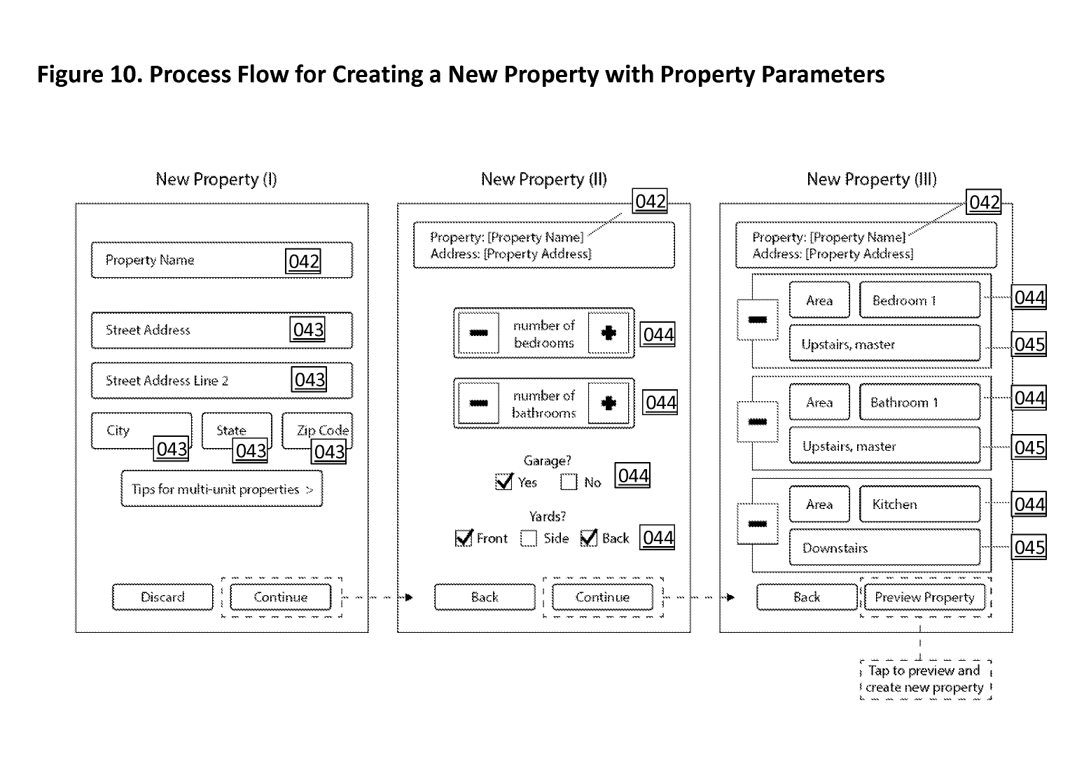

FIG. 10 illustrate an example of a “New Property” creation tool for creating properties with attributes on a mobile device for later inspection on any number of mobile devices.

Both New Property data as well as Shared Property Attribute creation or modification may be stored on a local database on the mobile device and made available for use to apply to any mobile generated content. Instructions for Shared Property Attribute creation or modification would be given a higher priority upload than any mobile content which had been tagged with such attributes. This would facilitate a mobile user to work with no or poor internet connectivity.

FIG. 10 details an example flow of interaction through different pages of the mobile application including setting the property name 042 and entering the property address 043. The figure demonstrates a “smart attribute” creation method for assigning recommended attributes by assessing preliminary user inputs 044. The user may then add, modify, or delete desired area attributes 044 as well as enter area description 045.

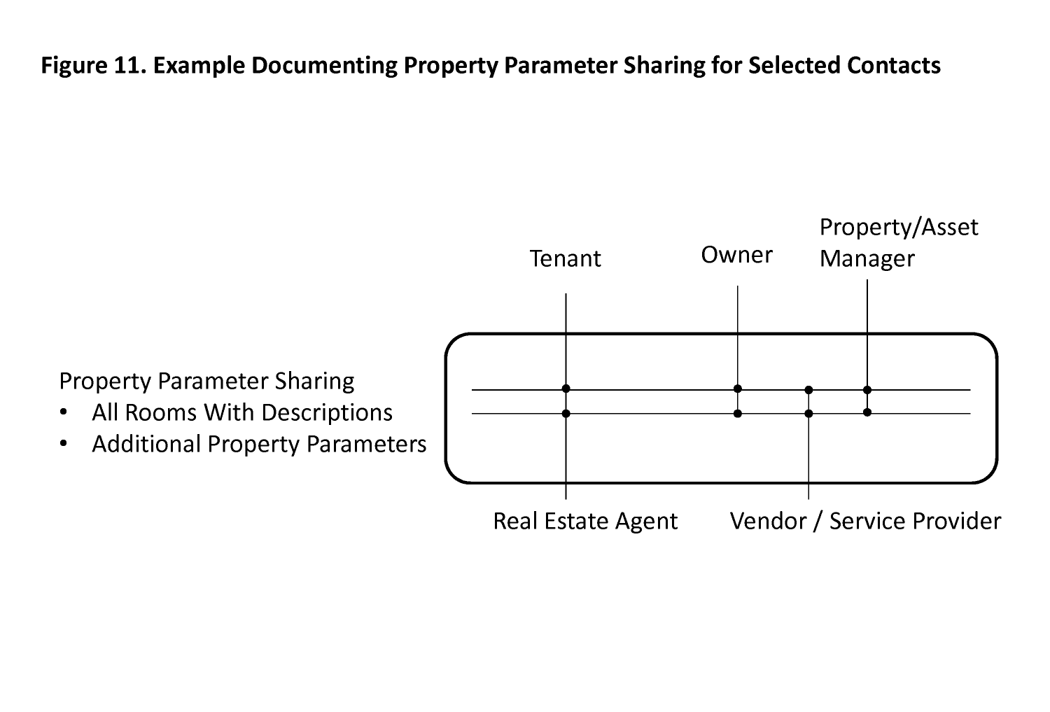

FIG. 11 illustrates an example process flow for sharing Property Parameters between users. The figure visualizes Property Parameter Sharing. In one embodiment of the invention sharing of Property Parameters is not necessarily linked to the sharing of notes or content.

The web portal may allow users to share their Notes and Property Parameters with other users. Notes and Property tag Parameters can be pushed from one user to another, or synced between multiple users. However, a distinction may be made that Property Parameters and Notes can be shared separately. Property Parameters may be globally available to all users without making a Note tagged with a Property Attribute globally available.

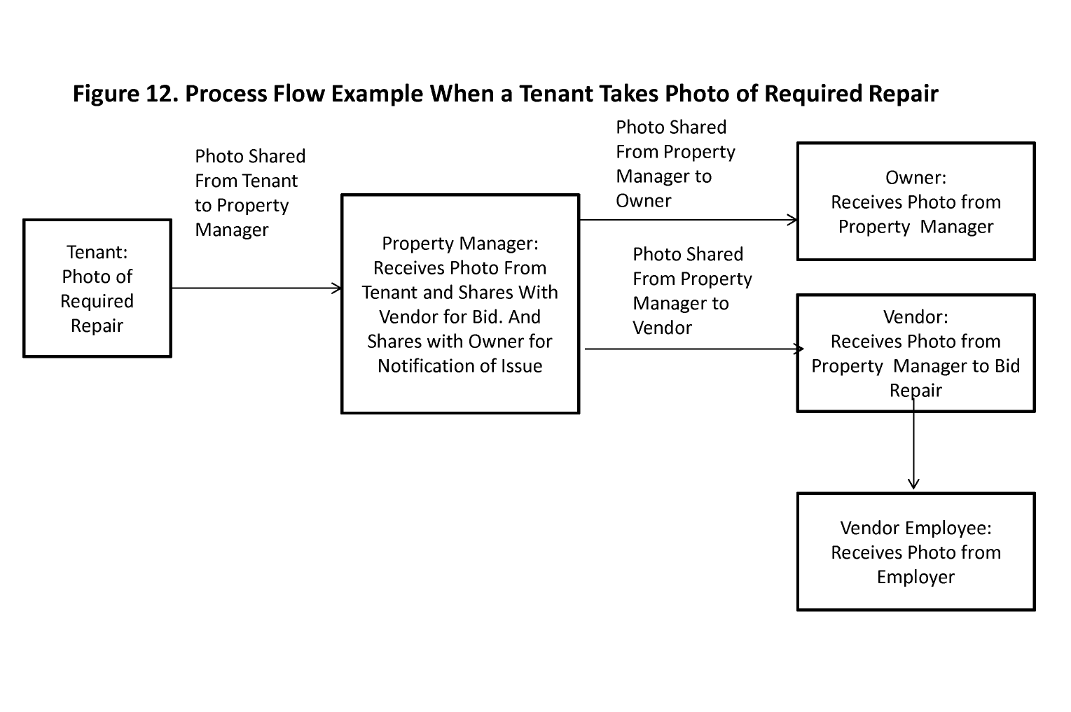

FIG. 12 illustrates one example process flow for sharing Notes between users. In the example, a photograph is taken by one user (a tenant) which is shared with another user (a property manager). The property manager may then share the photograph with other users, and so on. The system may be configured so that all users can change or edit the shared notes attributes and these changes may be in sync. In another configure, the note may be pushed from user and once pushed the changes to attributes made by one user do not impact that of another user. The arrows depict the flow of the photograph through the contacts in this particular example. A key element is that in this example is that the photograph may be shared between multiple people but only the users connected with an arrow are in each other's sharing network.

In this example, all parties may have Shared Property Attributes which facilitates a common reference point. However, each party may share the generated Content (a photograph, in this example) to other parties at their own discretion. Users may choose to edit Note Content such as reported Comments before sharing to other users.

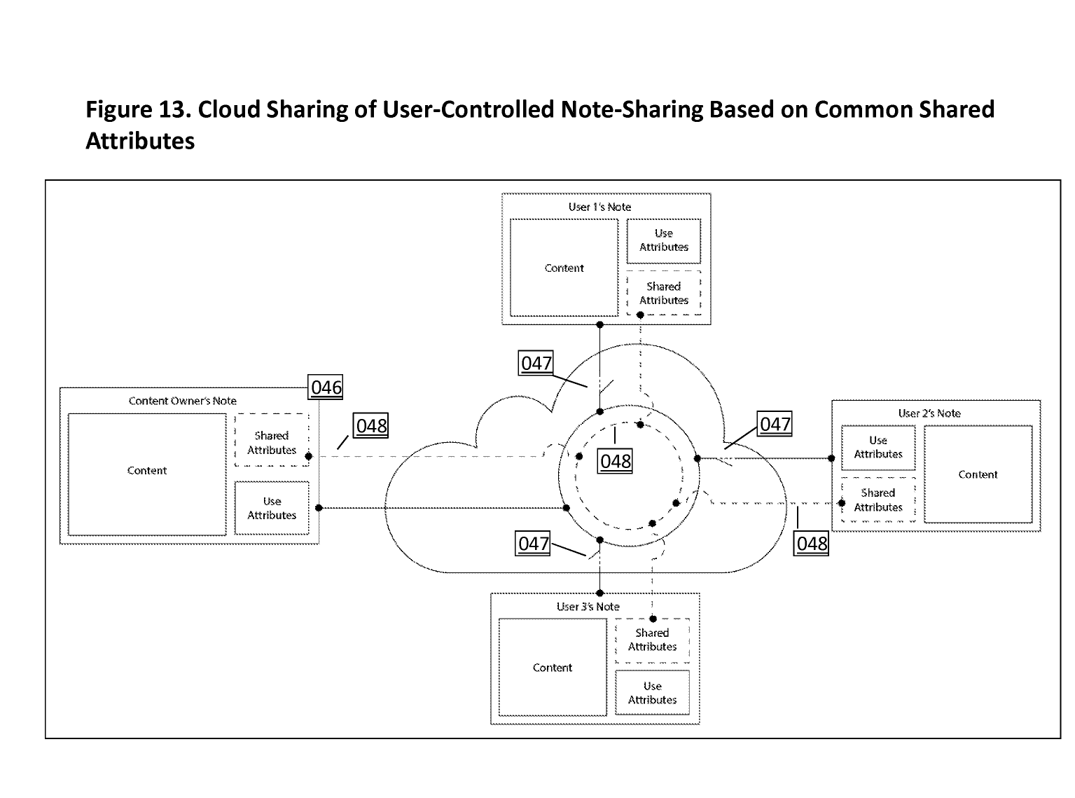

FIG. 13 illustrates how utilizing cloud data processing and storage that Shared Attributes can be made common within a Sharing Network while the specific content itself may be individually shared with controlled permissions to each user independently. Illustration of Note 046 sharing based on a Shared Attribute 048 framework.

A Shared Network may consist of multiple users or multiple groups of users where each user or groups of users may have varying permissions 047 including but not limited to: ability to make changes to notes, ability to share notes with other, ability to edit notes for their own use, ability to edit notes and synchronize changes back to other users, and others.

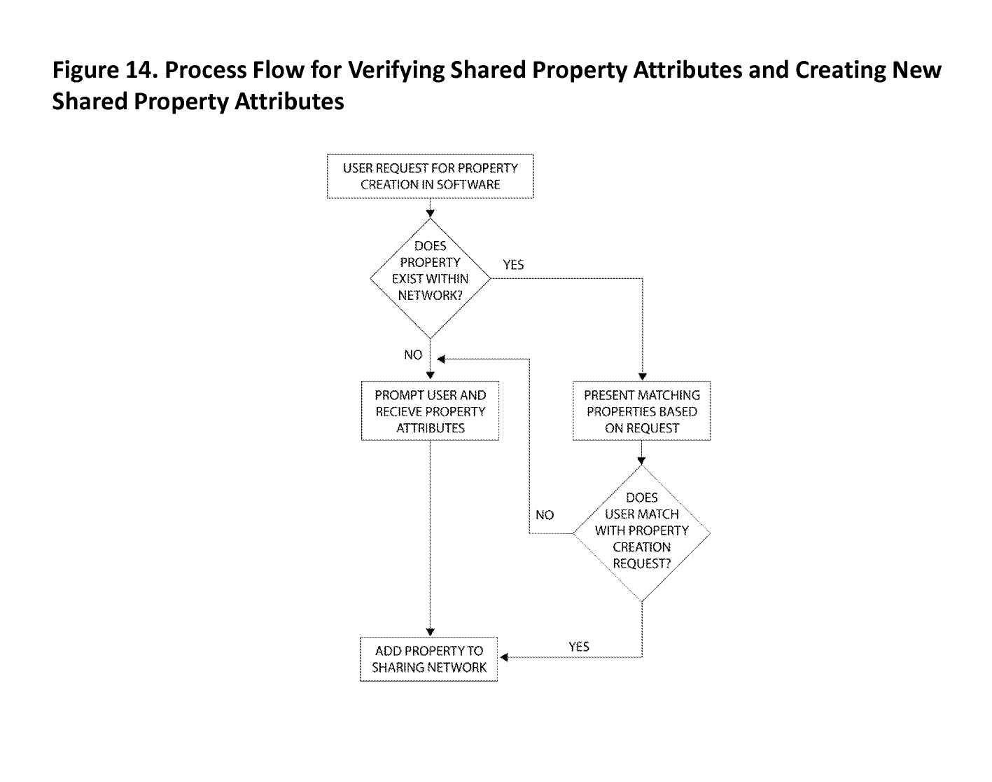

FIG. 14 illustrates the process flow for when a user wants to create new Shared Property Attributes. After receipt of the user request, the request may be first compared to other properties within the network to avoid duplication issues. If there are no duplication issues, then a new property with attributes may be added to the network. The network may refer to multiple users, groups of users, or the public at large as controlled by the sharing network request.

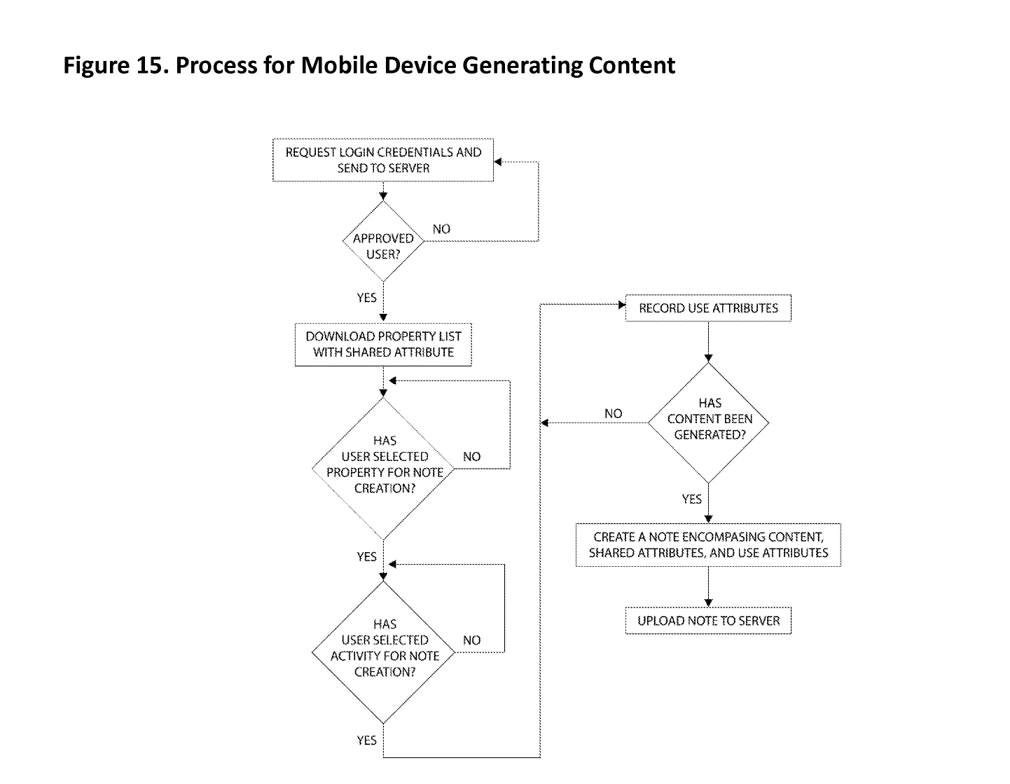

FIG. 15 illustrates an example process flow of the mobile software regarding how content is associated with both Shared and Use Attributes and then uploaded to the server for processing, sharing, or report generation. In the illustration, a user on a mobile device logs into a server. If the user is not an approved user, the user is allowed to either retry their login information or create a user account. Once it is determined that the user is valid and credentials have been verified, the property list and shared attributes are made available to the mobile device. The user then selects a property (such as a property name or address) for which content will be generated. In addition, the user selects the user activity. In the demonstrated example, the user selects the activity after selecting the property. In another configuration of the process flow, the activity type could be configured prior to selection of the property. In addition, the activity type could also be configured to be limited to the user type. For example, a repairs vendor may only have Maintenance as the only available Activity. A tenant may only have Check-in, Check-out, or Repairs Request as available activities.

The device may record other use attributes by monitoring users actions such as selecting from available use attributes on the graphical user interface or by collecting information such a user GPS location.

The user then generates or collects content. In the demonstrated an example, the user take a photo or selects a photo from available photos.

Once the user approves the content, a Note is created encompassing the content with the attributes.

In the demonstrated example, the note is uploaded in the background to the server. Many upload functions may be selectable or configurable by the user. For example, an upload queue may be utilized on the mobile device to facilitate rapid generation of content which may then be uploaded when an internet connection is available or only uploaded when a user is connected via WIFI if such option is configured.

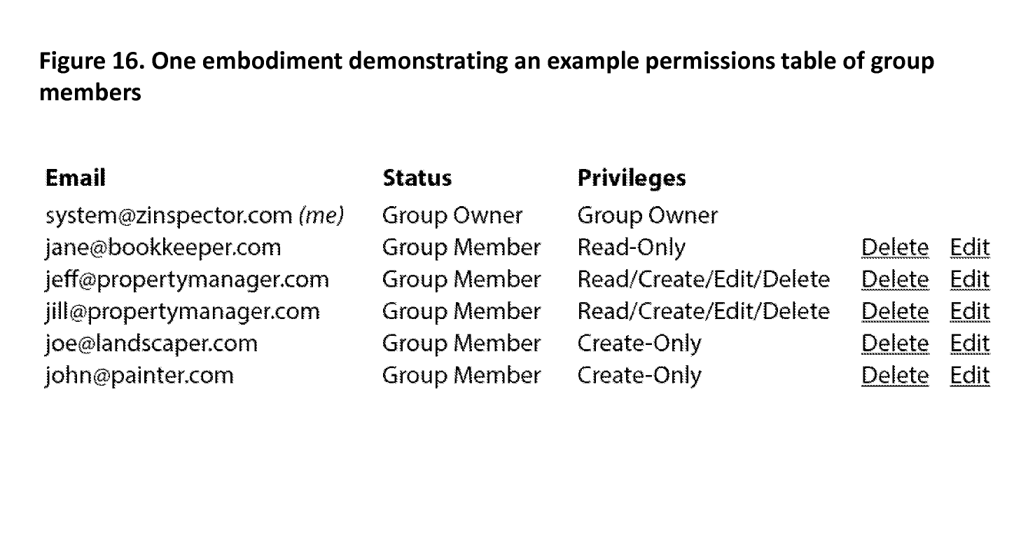

FIG. 16 demonstrates an example of group sharing. Where all members of the group share common property attributes available on their mobile devices. However, specific user permissions specify how users may Read, Create, or Delete notes and note content. For example, a landscaper working for a property manager may only have a Create account. This would allow the landscaper to take a picture of the work performed and upload it to the property managers system. But, the landscaper would not be able to login and see the wide assortment of photos or other content available to the property manager.

Furthermore, a group may be configured so that only certain group members or sub-group of group members may only have access to a particular properties or properties.

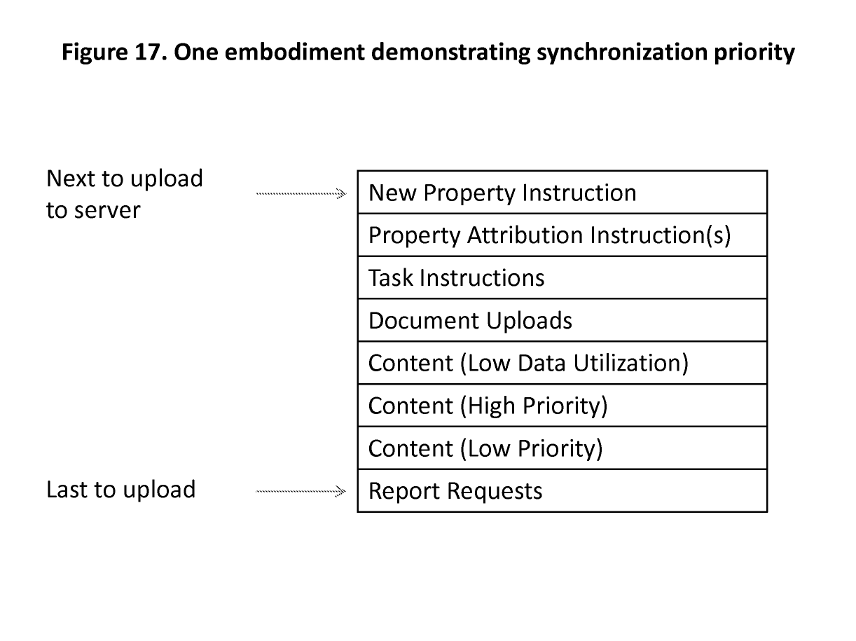

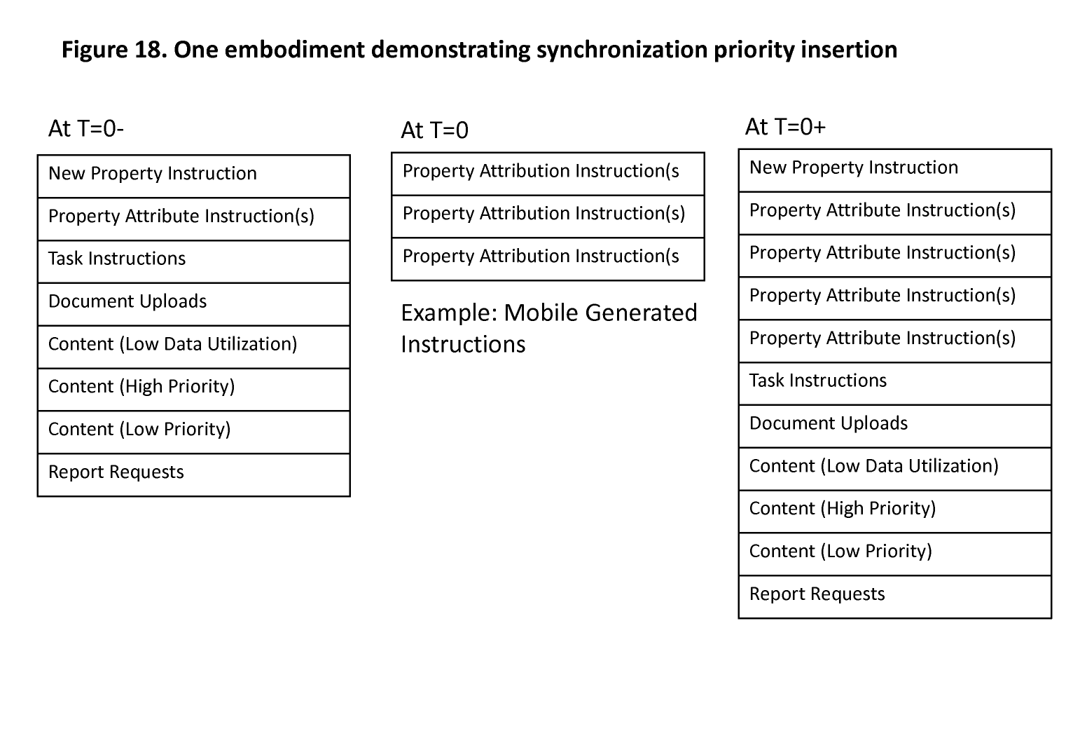

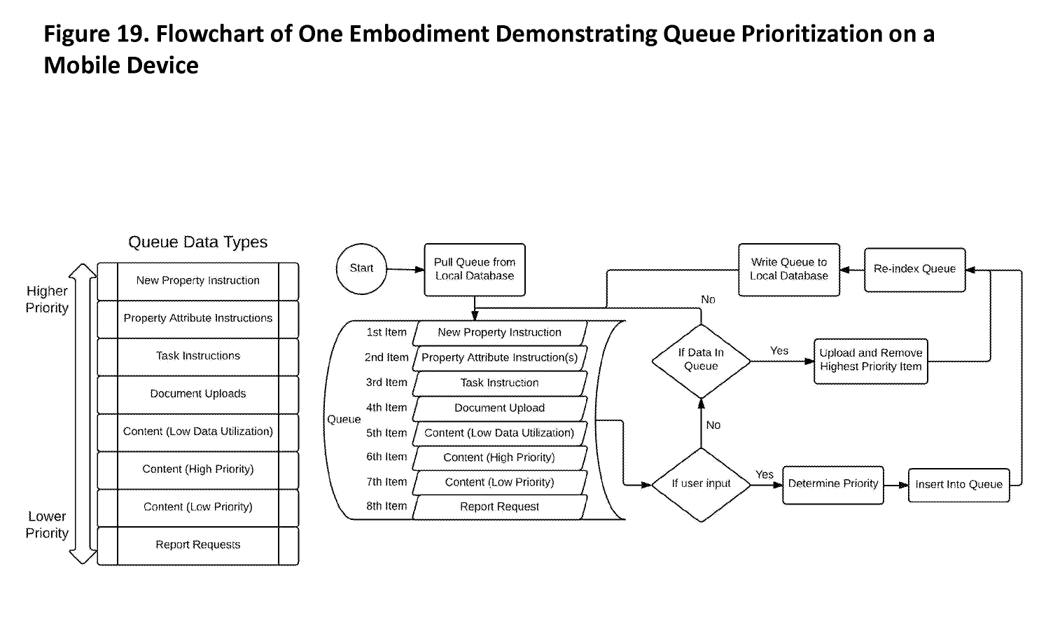

Any number of mobile devices can create new properties, set property attributes, modify property attributes, and generate content. The developed invention may include two or more synchronization data processes between the server and the mobile device(s). Furthermore, a data upload queue (FIG. 17) can be used to prioritize data uploads. In one embodiment, the property attributes are given a higher upload priority over generated content (FIG. 18). In such an embodiment as illustrated by the Flowchart in FIG. 19, the property attributes may be changed, for example, adding an Area type Bedroom with a Description of Master to the definition of the property may be considered a higher priority item and the server may quickly be updated with the new property attribute. The mobile device may then create content, such as taking photos, which are tagged with the new attribute of Bedroom:Master.

The invention encompasses multiple purposes for which this prioritization may occur. In one embodiment, a property attribute is given a higher prioritization as multiple devices may be used to inspect the same property. It is imperative that the property attributes remain in rapid sync across the devices despite the generated content being uploaded later. In addition, generated text notes from an inspection (a form of generated content) such as notes from a Move-Out Inspection may be given a higher prioritization over other generated content such as a photo. The inspection notes could be used by the office to schedule a cleaning vendor for items identified in the move-out inspection despite the photos not completing the upload process. For example, a Move-Out Inspection of a single family home may include over 200 photos which could take many minutes (or even hours) to upload and queue prioritization may further restrict the photos to upload with WiFi to limit mobile data consumption.

This queue prioritization process facilitates certain information to be sent to the server in front of other information which may or may not be slower to upload. In one embodiment, higher priority information may be made accessible to the central office despite mobile data upload rate limitations in the field. Furthermore, photos may also be tagged with Action Items and if given a high priority they may be given a higher prioritization in the queue.

Furthermore, a Report Request instruction can be give a very low priority instruction in order to be sure all property attributes, inspection notes, and photo content has been uploaded. A Report Request may be generated by user by tapping an icon[038], for example, or a Report Request may be generated automatically at the time a user indicates completion of a complete property inspection. In one embodiment, upon the server receiving a report request, the server will generate a PDF report for the requested activity including all uploaded content. The report may be sent to the user's email, other email addresses, or other appropriate archiving mechanisms including uploading to other data storage services like Evernote, Dropbox, Google Drive, or dotloop.

Furthermore, the mobile app may be used to generate Tasks and Documents. Property attribute instructions may be received by the server prior to Task creation instructions and Document uploads. Documents may be created by the user downloading templates as part of one of the mobile app synchronization process and then upon filling out the required document fields on the mobile app.

### SUMMARY

The systems and methods of the context based sharing platform integrate cloud data storage and mobile devices across multiple users. In some embodiments, the systems and methods may be used to share photographs and other information of a property which can be defined either through a web browser or on a mobile device. Once the key attributes of a property is defined, these definitions can be shared with selected contacts in the user's contact list. Multiple users may take, share, and access photographs using the same property and Area definitions on multiple devices. The photographs may be updated to the cloud and may be appropriately tagged with the relevant property definitions attributes, and activities.

The systems and methods of the context based sharing platform integrate cloud data storage and mobile devices across multiple users. In some embodiments, the systems and methods may be used to share photographs of a property which can be defined either through a web browser or on a mobile device. A property may be defined with key attributes such as Areas of a property including: number of bedrooms, number of bathrooms, other rooms, parking, outside areas, etc. In addition, an Area can be labeled with a more detailed description (eg. Bedroom 1: down hallway on left hand side). Once the key attributes of a property is defined, these definitions can be shared with selected contacts in the user's contact list or with members of a defined group or groups. Or, one's account may be configured to automatically share property attributes based on defined permissions of their group members. This critical element enables multiple users to take, share, and access photograph using the same property and Area definitions on multiple devices. The photographs are updated to the cloud and may be appropriately tagged with the relevant property definitions attributes, and activities.

The platform facilitates photograph grouping into a graphical interface based on customer needs including a Portfolio view and Timeline view. The software enables grouping, sorting, and searching for photographs by Property Address, Activity type, or other indicated characteristics. The photographs and views may be accessed through the cloud through a web browser on a computer or mobile device or the content could be synchronized with a computer or mobile device for improved local performance.

A queue prioritization algorithm is utilized to control the flow of instructions and content upload in order to maintain multiple device utilization, low mobile data utilization, and report generation.

I claim:

1. A contextual cloud content organization system, comprising:
Sharing property attributes between a server and a mobile device;
Generating property inspection content on a mobile device tagged with at least one shared property attribute and at least one use attribute.
Uploading property inspection content from a mobile device to a server.
Grouping of content based on a use attribute and viewing through a website.

2. The method of claim 1, wherein the use attribute is a user Activity

3. The method of claim 1, wherein the shared attribute is a property address.

4. The method of claim 1, wherein the generated content is a photograph.

5. The method of claim 1, wherein the generated content is a video, audio clip, report, document, or inspection observation

6. The method of claim 1, wherein a secondary shared property attribute is used to tag content,

7. The method of claim 6, wherein the secondary shared property attribute is one or more inspection areas of a property.

8. The method of claim 7, wherein a property consists of multiple inspection areas of the same type with each area given a unique description.

9. The method of claim 1, wherein a property has its inspection areas defined prior to the generation of content.

10. The method of claim 1, wherein users share property attributes separately from content.

11. The method of claim 1, wherein the mobile device and web server has a data upload queue priority process.

12. The method of claim 11, wherein property attribute data is given a higher upload priority over generated content tagged with such attributes.

13. The method of claim 12, wherein property attributes may be uploaded to the server using mobile data while the mobile generated content waits for WiFi to upload.

14. The method of claim 12, wherein content uploads are further prioritized based on a priority level set by the user at the time of content generation.

15. The method of claim 11, wherein a report request is given a priority lower than all generated content.
